(19) United States
(12) Patent Application Publication
(10) Pub. No.: US 2003/0195754 A1
(43) Pub. Date: Oct. 16, 2003

(54) Product deviation request tracking system

(76) Inventors: John E. Ford, Niskayuna, NY (US); Kevin Fuller, Albany, NY (US); Walter Andrew Wojtowicz, Delanson, NY (US)

Correspondence Address: PERKINS COIE LLP, PATENT-SEA, P.O. BOX 1247, SEATTLE, WA, 98111-1247, US

(21) Appl. No.: 10/121,018

(22) Filed: Apr. 10, 2002

(51) Int. Cl. G06F 17/60; G06F 7/00; G06F 17/30

(52) U.S. Cl. 705/1

(57) ABSTRACT

A method and system in a computer for tracking requests for deviations, such as deviations to products, is provided. The computer system receives information associated with a request for deviation. After a review of a request, the computer system receives an indication of a decision for the request resulting from the review. When requested by a user, the computer system generates a report indicating open items identified during the review. Once the open items have been completed, the computer system receives an indication that an open item has been completed. When a final decision for the request is reached, the computer system receives an indication of the decision.

### TECHNICAL FIELD

The described technology relates generally to tracking information and, more specifically, to tracking information related to requests for deviations from a product.

### BACKGROUND

In many businesses, customers may place requests for new product features or items. Such requests may be satisfied in the short-term by customizing currently existing products. Even if customization of an existing product is not feasible, customer requests may also play a role in new long-term product development activities.

To be used in this way, however, product developers and product sales representatives need somehow to be able to track and access customer requests over time. Currently, customer requests are recorded onto forms using word processing software, such as Microsoft Word. A hard copy of a request form is typically filed by date. It is difficult to search these hard copies for a particular request, and tracking multiple issues specific to one sale is difficult. In addition, once a short-term decision is reached with respect to handling a particular request, the request is typically filed away, and obtaining access at a later time may become difficult. Subsequently, the request may remain unknown to a product developer (e.g., product designer, engineer) who may have otherwise found the request useful when designing a new product.

It would be desirable to have a tool that will allow users to record and track customer requests for deviations from products and the corresponding decisions related to handling the customer requests.

### BRIEF DESCRIPTION OF THE DRAWINGS

FIGS. 1-20 are web pages that illustrate the user interface of the product deviation request tracking system in one embodiment.

FIG. 21 is a block diagram illustrating components of the request tracking system in one embodiment.

FIG. 22 is a flow diagram illustrating the entering of a new request into the request tracking system.

FIG. 23 is a flow diagram illustrating the displaying of request information by the request tracking system.

FIG. 24 is a block diagram illustrating data structures of a sample database in one embodiment.

### DETAILED DESCRIPTION

A method and system for tracking customer requests for deviations to products (physical products and services) are provided. In one embodiment, a request tracking system allows a user (e.g., product manufacturer, engineer, administrator, sales person, etc.) to input various levels of customer request information, revise and modify the inputted request information, search for saved request information, and submit request information for review by a decision making authority, such as a review board (e.g., Product Policy Board). For example, a product sales person may receive a request from a customer relating to a particular product that the customer may purchase and wishes to have modified. The sales person may then input the received customer request information into the request tracking system, using, for example, a web-based database tool.

The request is typically reviewed by an administrative review board so that a decision may be reached on how to proceed with the request. Once request information is inputted into the request tracking system and submitted for review, selected administrative users (e.g., review board members) receive an indication that the request information has been submitted for review. In one embodiment, the indication may be in the form of an automatically generated electronic mail (“e-mail”) message. One skilled in the art, however, would appreciate that other means of notifying users are possible, such as, for example, a phone message or a notice posted to a personalized web page. The selected administrative users may then retrieve the request information, revise and modify the request information, and review the request information as part of an administrative review process.

The outcome of the administrative review process may include a decision on how to proceed with the request. An administrative user will, ultimately, input decision information into the system. The decision information could include, for example, customizing a currently existing product to incorporate the customer request, denying the request, or indicating that additional information should be provided before reaching a final decision on the request.

When more information is needed before reaching a final decision on how to proceed with a request, the indication that more information is needed may take the form of an open item. One or more individuals may be assigned responsibility for an open item. Thus, in one embodiment, the existence of an open item may be made known to responsible individuals via an automatically generated e-mail message or report. When the status of an open item changes, a user may then input into the system information related to the status of the open item. In this way, open items may be tracked along with customer requests.

Even after an ultimate decision on how to proceed with a request is reached, request information stored within the request tracking system may still be used for designing future products. A user (e.g., product designer, engineer) may access the entire body of customer request information stored within the request tracking system using custom search queries. The request tracking system's custom search capabilities are facilitated by the use of a standardized method for initially inputting request information into the system's database, including the use of keyword information. In one embodiment, this standardization is achieved through the use of a web-based database tool that provides open text fields for data input, text fields with drop-down menus, and text areas.

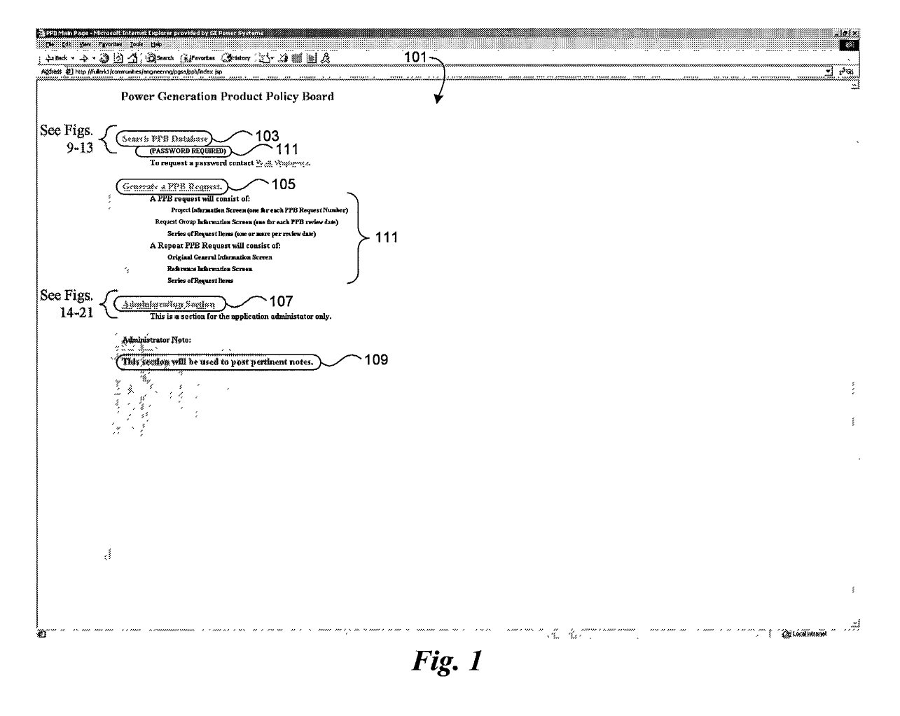

FIGS. 1 through 20 are representative computer displays or web pages that illustrate the user interface of the request tracking system in one embodiment, such as for use by a product manufacturer. The web pages may be implemented in XML (extensible markup language) or HTML (hypertext markup language). The web pages provide facilities to receive input data, such as open text fields, drop-down menus that allow one or more of several entries to be selected, buttons, sliders, or other known user interface tools for receiving user input in a web page. Of course, while one or more ways of displaying information to users in web pages are shown and described herein, those skilled in the relevant art will recognize that various other alternatives may be employed. The terms “screen,” “web page,” and “page,” are generally used interchangeably herein. While XML and HTML are described, various other methods of creating displayable data may be employed, such as the wireless access protocol (WAP).

The web pages shown herein are stored as display descriptions, graphical user interfaces, or other methods of depicting information on a computer screen where the layout and information or content to be displayed on the page is stored in a database. In general, a “link” refers to any resource locator identifying a resource on a network, such as a display description provided by an organization having a site or node on the network. A “display description,” refers to any method of automatically displaying information on a computer screen using XML, HTML, WAP or other formats, such as e-mail based or character/code-based formats, algorithm-based formats (e.g., vector generated), or matrix or bit-mapped formats. While aspects of the invention are described herein using a networked environment, some or all features may be implemented within a single-computer environment.

FIG. 1 illustrates a main page 101 for a user of the request tracking system. The main page 101 is the user's entry point into the request tracking system. Although not depicted in this particular example, the main page 101 may be customized for each user of the system. In this embodiment, a password is required to access aspects of the request tracking system. Those skilled in the relevant art would appreciate, however, that other mechanisms may be utilized to control access to the request tracking system.

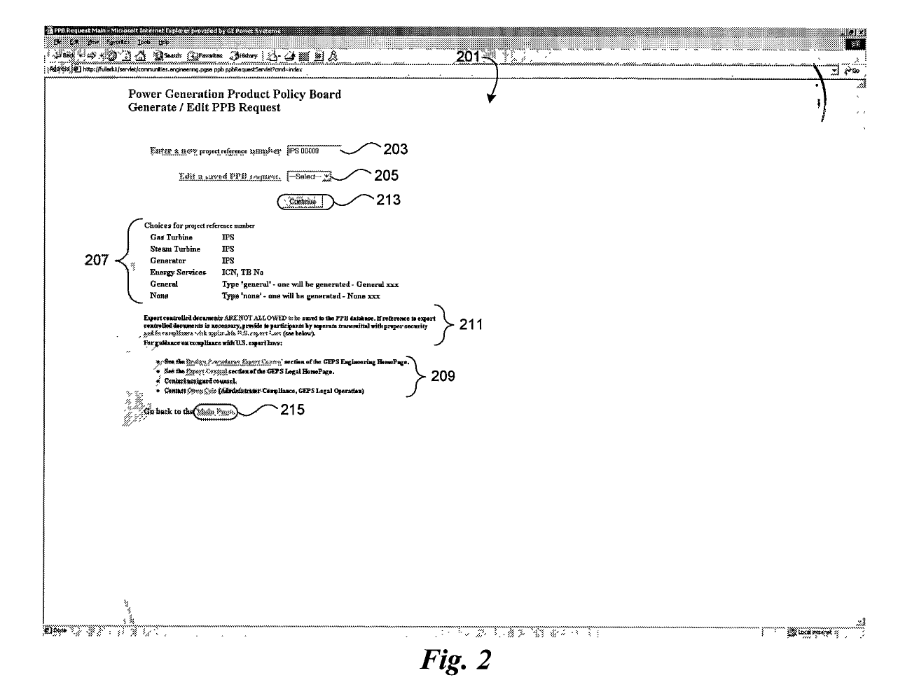

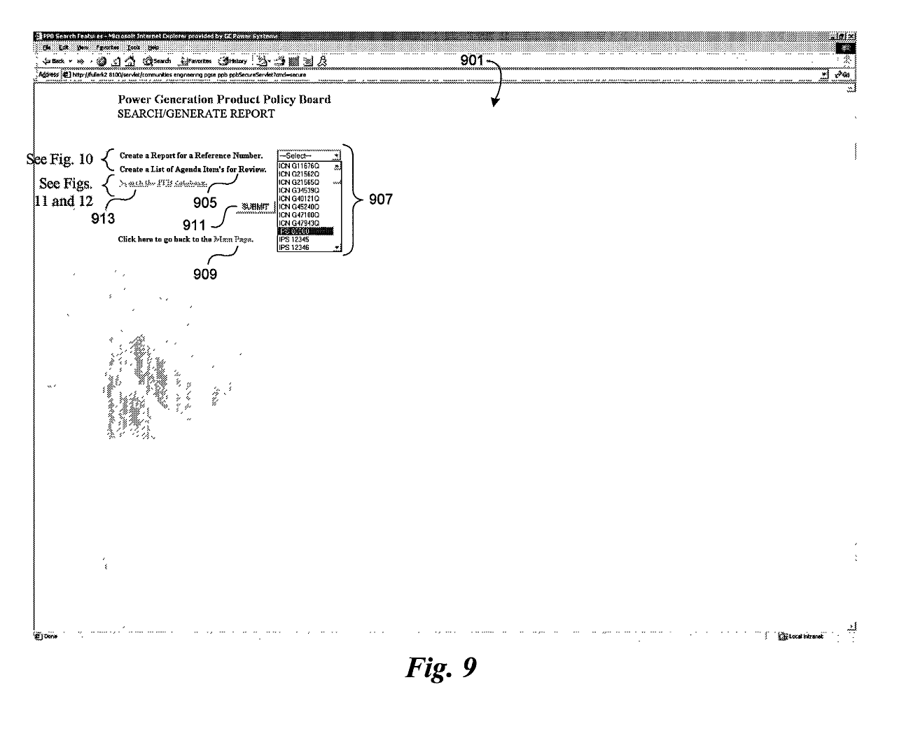

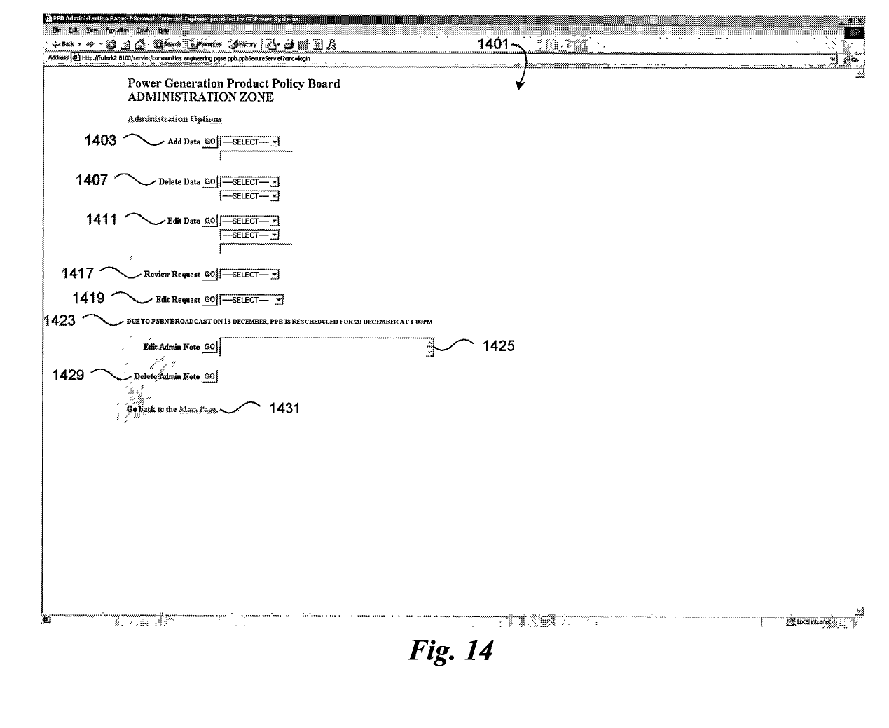

From the main page 101, a user may navigate the request tracking system via links to other system web pages. A search database link 103, when selected by the user, causes retrieval and display of an appropriate search screen, such as the search/generate request page 901 of FIG. 9. The main page also includes a request link 105, which if selected by the user, causes retrieval and display of a generate/edit request screen, such as the web page 201 of FIG. 2. The main page 101 also includes an administration section link 107, which when selected, causes the retrieval and display of an administration options page, such as the administration options page 1401 of FIG. 14. In addition to displaying links to various web pages that allow a user to track, input, and review requests for product deviations, the main page 101 may also may include general information 111 and notices 109 that relate to the request tracking system.

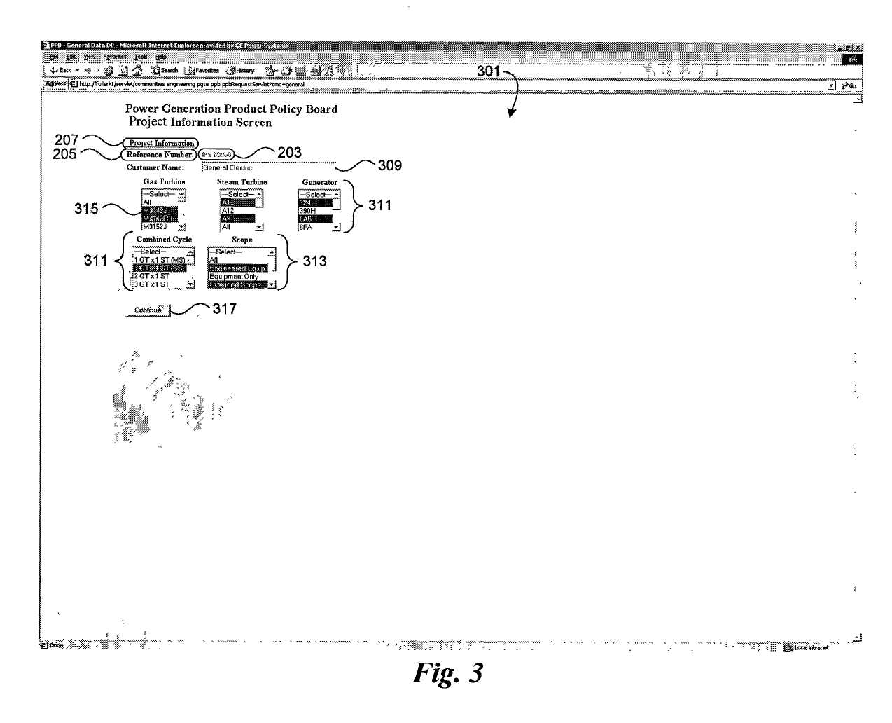

FIG. 2 is an example of a generate/edit request page 201, the starting point for generating a new request or editing an existing request. The generate/edit request page includes a project reference number text field 203. A user creating a new request enters a number into the project reference number text field 203. In order to assist the user in entering a project reference number, general project reference information 207 is provided. In this example, the project reference number “IPS 0000” has been entered into the project reference number text field 203. Once a new project number is entered into the project reference number text field 203, the user may select a continue button 213 to proceed to a project information screen, such as the project information screen 301 of FIG. 3.

In this embodiment, the request tracking system allows the user to organize customer requests by project and by request groups within a project. For example, a project may correspond to the building of a new power plant. One request group for the project may correspond to customer requests relating to noise issues, and another request group may correspond to customer requests relating to emissions issues. Thus, a user can select the desired project and request group to access all the related customer requests.

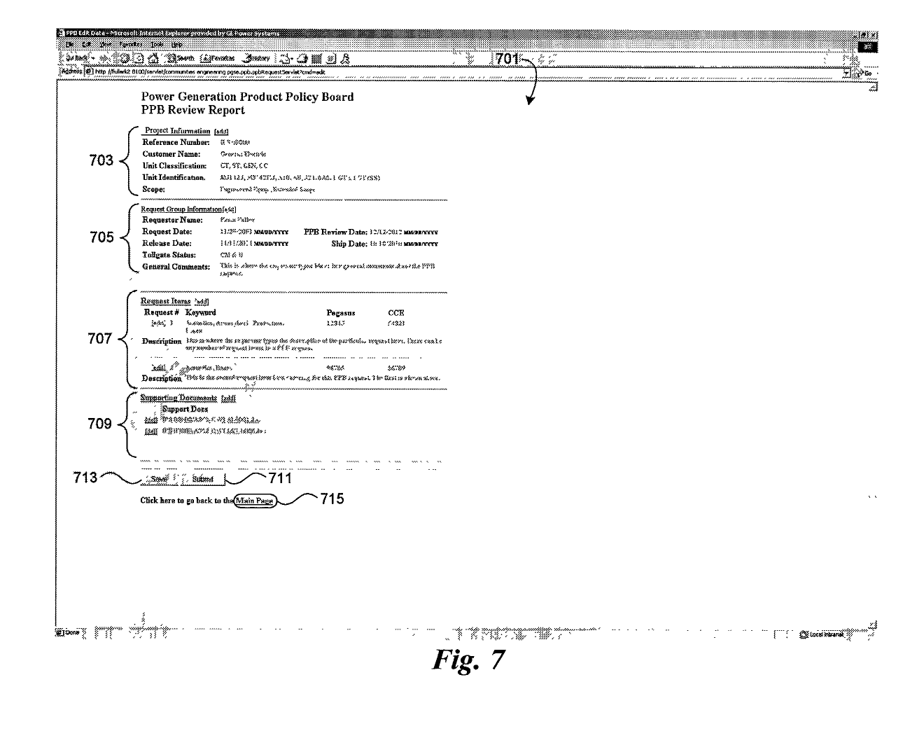

Alternatively, a user wishing to edit a request that has been previously inputted into the system but not yet submitted for review may do so from the generate/edit request page 201 by selecting a project reference number from an edit a saved request drop-down menu 205. The edit a saved request drop-down menu 205 lists all the saved requests that the user may access for editing purposes. Once a new project number is selected from the edit a saved request drop-down menu, the user may select the continue button 213 to proceed to a review report page, such as the review report page 701 of FIG. 7.

Export control information 207 is displayed on the generate/edit request page to assist the user in complying with security procedures for export control documents. This information includes various links 209 to export control information web pages. The user may return to the request tracking main page 101 of FIG. 1 by selecting a main page link 215.

FIG. 3 is an example of a project information page 301 that allows a user to input project information associated with one or more customer requests. In this embodiment, the project information page is reached via the generate/edit request page 201 of FIG. 2, after the user enters a project reference number and selects the continue button 213 of FIG. 2. In this example, the user inputs a customer name into a customer name text field 309. Additionally, the user selects unit classification information (e.g., gas turbine, steam turbine, generator, combined cycle) and unit identification information (e.g., model number) by selecting unit identification data 315 from at least one of the four unit classification drop-down menus 311 depicted in this example. The user also enters project scope information by selecting entries from a scope drop-down menu 313.

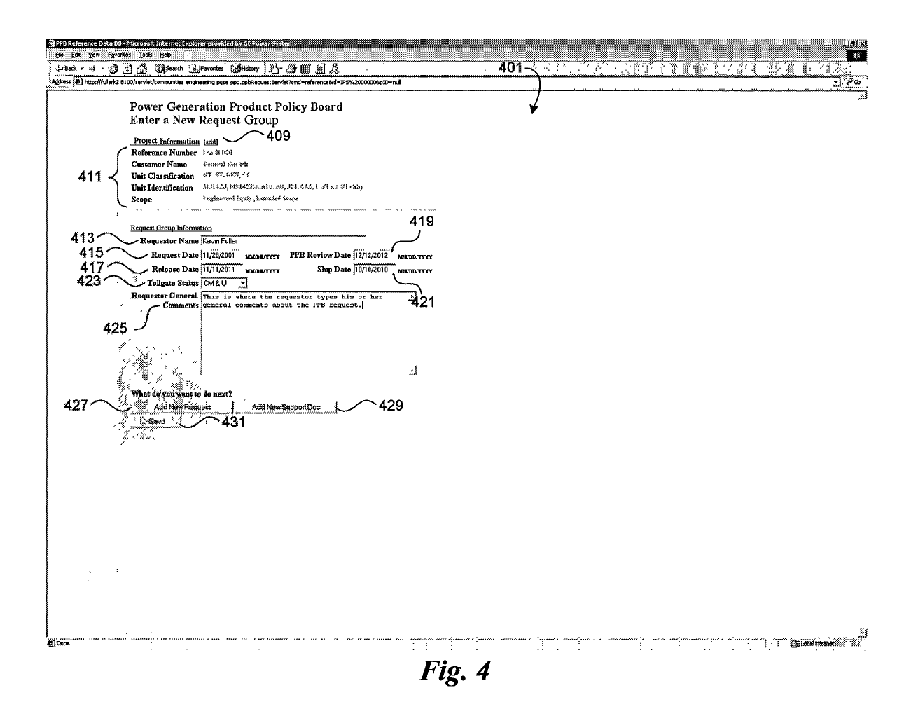

Once the user inputs project information into the various information text fields and drop-down menus of the project information page 301, the user may then select a continue button 317, which causes the display of a request group information page, such as the request group information page 401 depicted in FIG. 4.

FIG. 4 is an example of an enter a new request group page used for inputting new request group information into the review tracking system. The enter a new request page 401 allows the user to view project information inputted into the system via a project information page, such as the project information page 301 of FIG. 3. Project information is displayed in a project information text area 411. In this example, project information includes a project identification reference number, a customer name, unit classification information, unit identification information, and scope information. One skilled in the art would appreciate, however, that other types of information may be displayed in a similar display area. Should the user wish to edit information contained in the project information area 411, the user may select an edit link 409 to return to the project information page 301 of FIG. 3.

Besides displaying project information, the enter a new request group page 401 in this embodiment allows the user to input request group information via text fields, text areas, and drop-down menus. In this example, request group information includes the name of the user inputting the request 413, the date that the request was generated 415, and the date that the request is scheduled for review 419. The request group information may also include information for the product or standard product offering associated with the request, including a product release date 417, a product ship date 421, and a product tollgate status 423. The enter a new request group page 401 also includes a requester general comments text area 425 in which the user inputs his or her general comments pertaining to the request. One skilled in the art, however, would appreciate that other types of request group information may be entered into the system in other embodiments.

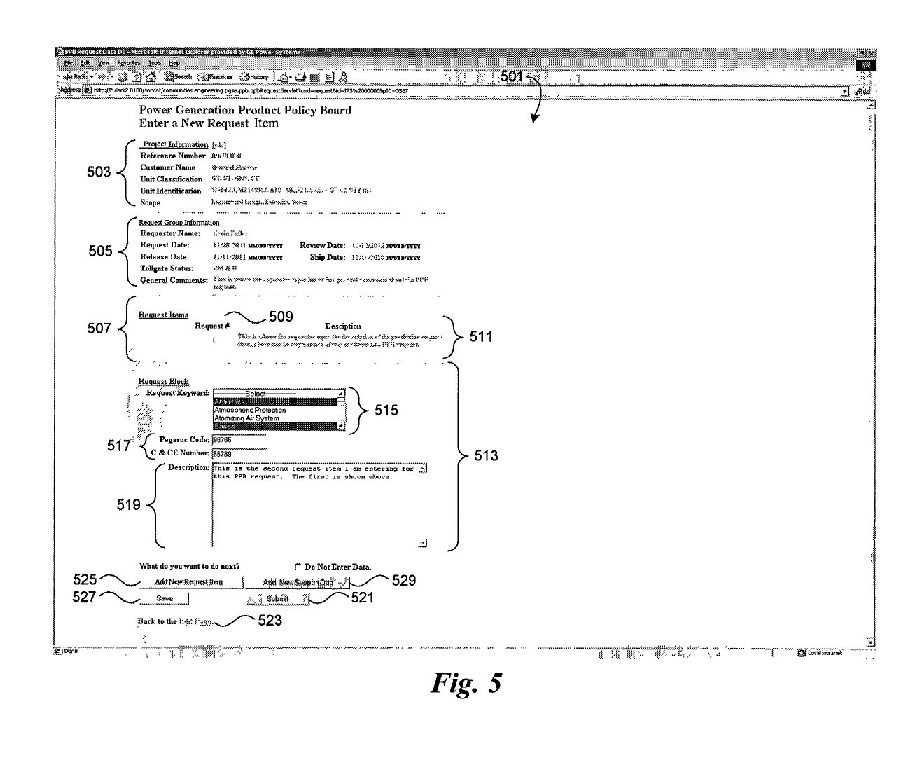

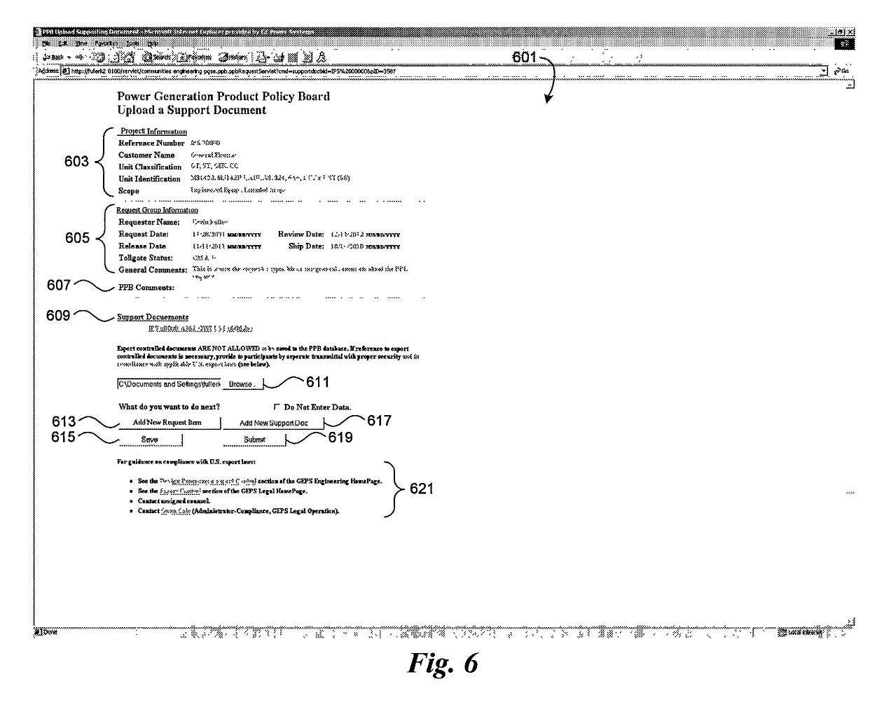

Once the user enters request group information into the various text fields and text areas, the user may add one or more request items to the request group by selecting a new request item button 427, which causes the display of an enter a new request item page, such as the enter a new request item page 501 of FIG. 5. The user may also add supporting document information to the request group by selecting an add new supporting document button 429, which causes the upload and display of a new supporting document page, such as the new supporting document page 601 of FIG. 6. The user may also save the entry for later modification by selecting a save button 431.

FIG. 5 is an example of an enter a new request item page 501 that allows the user to input new request item information into the request tracking system. In this embodiment, project information 503 is displayed. The enter a new request item page 501 also displays request group information 505 inputted by the user via the enter a new request group page 401 of FIG. 4. A request item that was previously entered into the system is displayed in a request items area 507, including a brief description 511 of the request item. Each request item displayed in the request items area 507 is numbered 509 according to the order in which it was inputted into the system.

The enter a new request item page 501 allows the user to input new request item information via various text fields and drop-down menus within a request block area 513. To enter a request item, the user selects one or more keywords from a request keyword drop-down menu 515. The keywords provide quick reference information about a request item and facilitate searches of the request tracking database. The user may input additional request item reference information 517 (e.g., Pegasus Code, C & CE Number) that further identifies the request item. The user also inputs a description of the request item using a description text area 519.

Once request item information is entered into the various text fields, drop-down menus, and text areas of the enter a new request item page 501, the user may then add additional request items by selecting an add new request item button 525. In this example, selecting the add new request item button will cause a new enter a new request item page to be displayed. The new enter a new request item page will display all the previously entered request items in a request items area. If the user wishes to add a supporting document to support the request, the user may select an add new supporting document button 529, which causes the retrieval and display of an upload supporting document page, such as the upload supporting document page 601 of FIG. 6.

When the user is finished adding request items and supporting documents, the user may submit the request for review by selecting a submit button 521. The user may also save the current request information without submitting it by selecting a save button 527. This will allow for further modification of the request information at a later time prior to submitting the request to the Product Policy Board for review. To immediately edit either the project information 503 or the request group information 505 displayed on the enter a new request item page 501, the user may select an edit page link 523. In one embodiment, the request tracking system may not allow the user to modify the information relating to a request item after it is submitted.

FIG. 6 is an example of an upload a support document page through which a user can upload a document that supports a request group. In this embodiment, the user accesses the upload a support document page 601 via the enter a new request item page 501 of FIG. 5 by selecting the add new support doc button 529 of FIG. 5. The user may also access the upload a support document page 601 from the enter a new request group page 401 of FIG. 4 by selecting the add new support doc button 429 of FIG. 4. The upload a support document page displays project information 603 and request group information 605. Along with the request group information 605, a comments area 607 is provided so that a user may view any comments submitted by administrative users (e.g., review board members). A support documents area 609 is displayed, which allows the user to view currently submitted supporting documents. The support documents section 609 of the upload a support document page 601 also includes a browse button 611, which if selected, allows a user to browse a system accessible storage device (e.g., disk-drive) to search for documents that support the request.

Once the user selects a supporting document, the user may then upload the supporting document into a document store or other storage device within the request tracking system. In one embodiment, the entire supporting document may be uploaded into a document store within the request tracking server system. The document store may be controlled by a standard file system. The request tracking system may create a folder for each project and a sub-folder for each request group for storing the uploaded documents. A link to the supporting document is then established using a reference to the path and file name of the document. One skilled in the art would appreciate that various other methods of incorporating both internal and external documents into the request tracking system are possible.

When document uploading is complete, the user may add additional supporting documents by selecting the add new support documents button 617. The user may also save or submit the request by selecting either a save button 615 or a submit button 619. Alternatively, the user may request to add a new request item by selecting an add new request item button 613. This will cause the display of the add new request page 401 of FIG. 4. For security purposes, general information relating to export control procedures is also provided 621, as well as links to other export control information.

FIG. 7 is an example of a review report page 701 generated by the request tracking system. In this example, the review report page 701 displays all the inputted request information associated with a particular request group before the request group is submitted for review. In this embodiment, the review report page 701 is displayed when the user selects the submit button 521 of FIG. 5 or the submit button 619 of FIG. 6. The review report page 701 provides a final opportunity for the user to edit request information before submitting the request group for review.

A project information section is displayed 703, along with a request group information section 705, a request items information section 707, and a supporting documents information section 709. From the review report page, the user may select either to save the request for further modification at a later time by selecting a save button 713, or to submit the request for review by selecting a submit button 711. Requested items are then ready to be added to a review agenda. The user may also return to the main page by selecting a main page link 715.

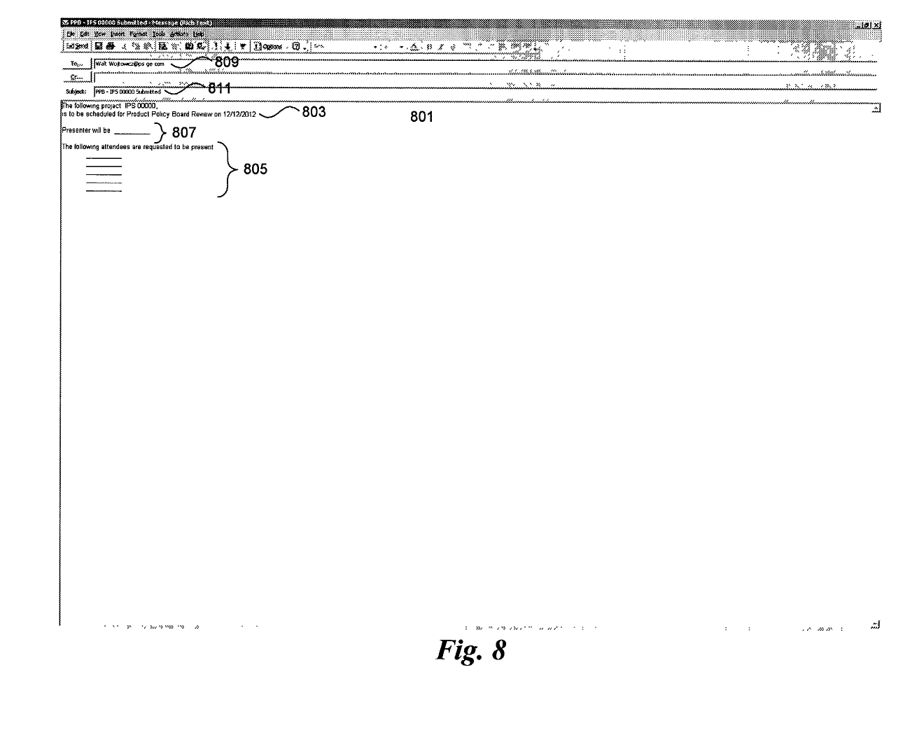

FIG. 8 is an example of an e-mail message generated by a request tracking system once a request is submitted for review. The e-mail message is generated when the user selects the submit button 711 of FIG. 7. Recipients of this e-mail are listed in the recipient line 809 of the e-mail and include the administrative users responsible for reviewing the request (e.g., members of a review board). The e-mail contains a subject line 811 that identifies the project by its identification number and indicates that the project request has been submitted. The e-mail body 801 contains the project identification number, as well as the review date 803 on which the request is scheduled for review. The request tracking system may maintain a schedule of Product Policy Board review meetings and automatically schedule a submitted request for the next scheduled meeting. The body of the e-mail includes an indication of the person that will be presenting the request to the review board 807. The e-mail body 801 also includes a list of attendees 805 that are requested to be present at the review. The user would typically enter the names of the presenter and the requested attendees and then send the e-mail.

Referring to FIGS. 9 through 13, various pages that display features available for tracking submitted requests are shown. FIG. 9 is an example of a search/generate report page 901. In this embodiment, the search/generate report page 901 is accessed by selecting the search database link 103 of FIG. 1. The search/generate report page 901 displays three user options in this embodiment. The user may prompt the request tracking system to create a report for a particular reference number by selecting a number from a report reference number drop-down menu 907. The user may also prompt the request tracking system to generate a list of agenda items for review by selecting a reference number from a create a list of agenda items for review text box 905, which also contains a list of project reference numbers. In this illustration, however, the create a list of agenda items for review text box 905 is currently hidden by the create a report for a reference number drop-down menu 907. Once the user selects a reference number from the create a report for a reference number drop-down menu 907 or the create a list of agenda items for review text box 905, the user submits the request by selecting a submit button 911.

From the search/generate report page 901, the user may also select the search database link 913 in order to search the database or select the main page link 909 to return to the main page 101 of FIG. 1.

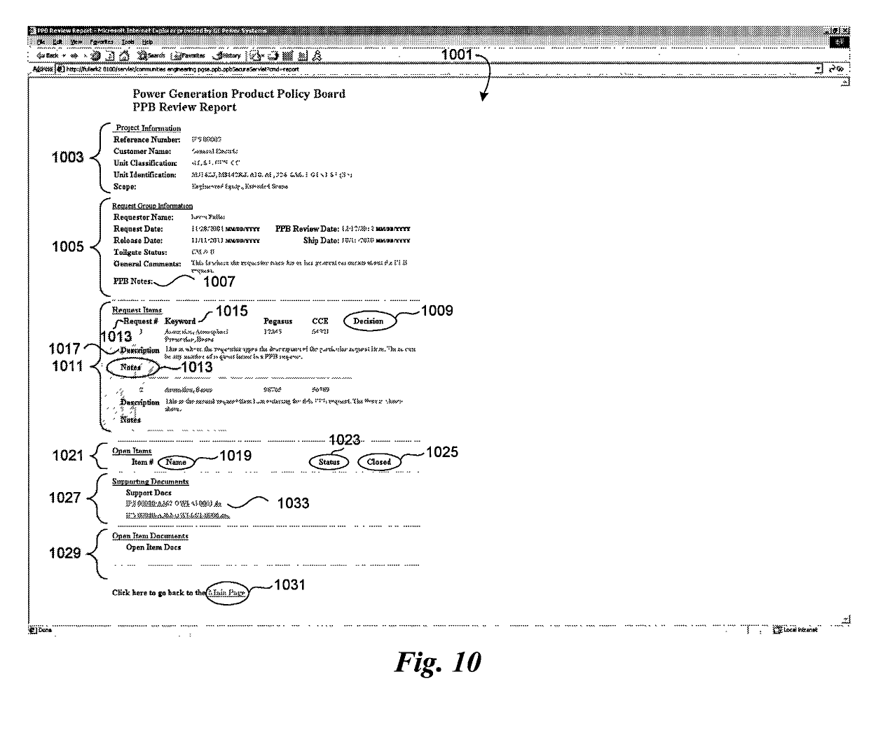

FIG. 10 is an example of a review report page 1001 that displays request information after it is submitted for review. In this embodiment, the review report page 1001 displays project information 1003 and request group information 1005. A notes section 1007 is included with the request group information 1005 in order to display notes inputted into the system by an administrative user (e.g., review board member). Request items are also displayed in a request items section 1011. Each request item includes a request item number 1013 that corresponds to the order in which the request item was inputted into the system, and a keywords section 1015 listing any keywords related to the request item. Additional request item reference information (e.g., Pegasus Code and C & CE Number) is also displayed in the request items section 1011, along with a description 1017 of each request item.

The request item section 1011 of the review report page also includes a decision section 1009 in which decisions (e.g., “approved” or “rejected”) related to a request item are posted. In this particular embodiment, each individual request item will ultimately receive a decision. A notes section 1013 for each request item is provided in order to display any notes input into the system by an administrative user (e.g., review board member).

The review report page 1001 also includes an open items section 1021 that lists open items in the order in which they are inputted into the system. Other information associated with each posted open item is also displayed, including the name 1019 of a person responsible for the open item, the status 1023 of the open item, and the closing date 1025 of the open item. An open item documents list 1029 is also displayed, which allows the user to link to open item documents submitted by administrative users. Similarly, a list of supporting documents 1027 related to the request group is displayed. In this particular embodiment, selecting on an open item document link or supporting document link 1033 allows the user to access the documents located in a disk-drive or other storage device that is accessible by the request tracking system, either directly or via a network connection. From the review report page 1001, the user may select the main page link 1031 to return to the main page 101 of FIG. 1. In this example, only one request group is identified for the project. If multiple request groups had been defined, then similar information would be displayed for each request group.

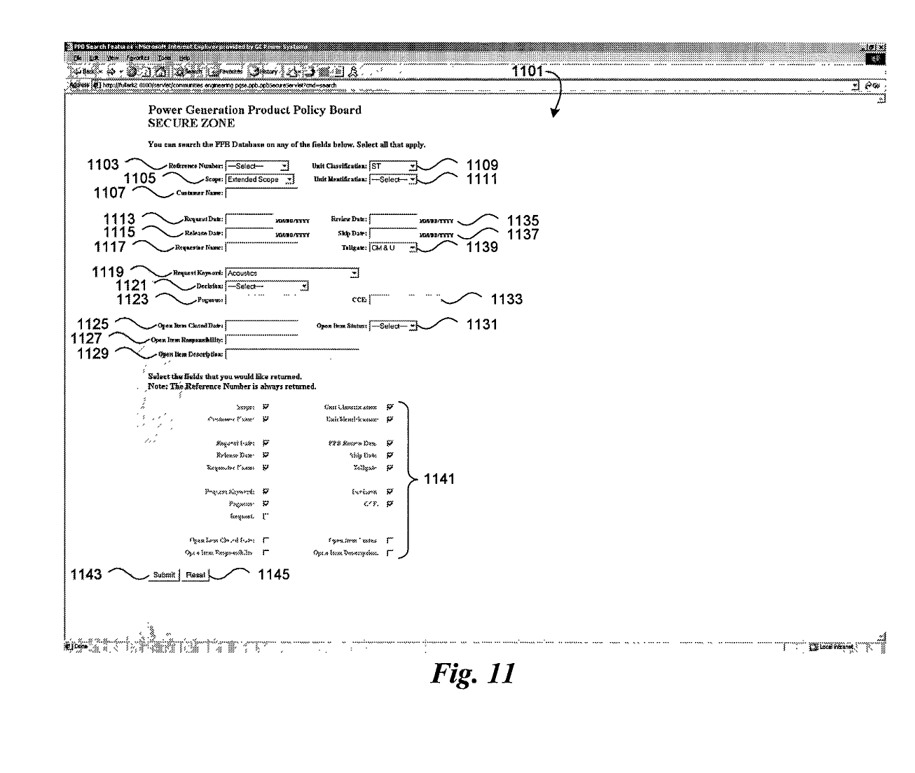

FIG. 11 is an example of an enter search query page 1101. From this page, a user may input parameters for a search of the request tracking database. In this embodiment, the enter search query page 1101 is accessed via the search database link 913 of FIG. 9.

From the enter search query page 1101, the user may select from multiple search options. The user may input search criteria using any combination of several provided text fields and drop-down menus. For example, as illustrated here, the user may input a reference number that identifies the project by selecting a number from a reference number drop-down menu 1103. The user may also search by unit classification, unit identification, or scope using a unit classification drop-down menu 1109, a unit identification drop-down menu 1111, or a scope drop-down menu 1105 respectively. A user may also search by request item keyword using a request keywords drop-down menu 1119. Because the various search options listed above may be product specific, rather than customer or project specific, the search options may be useful when the requests are being used to aid in new product development. For example, an emissions engineer may want to access all request items relating to emissions of a certain type of unit, such as a steam turbine. In such a case, the engineer may select steam turbines (“ST”) as the unit classification 1109 and select the keyword 1119 of “emissions.” In another embodiment, description searches do not need to be product specific and may include full text searches.

In this embodiment, customer or project specific search options are also available, including searches by customer name using a customer name text field 1107, request date using a request date text field 1113, release date using a release date text field 1115, requester name using a requestor name text field 1117, review date using a review date text field 1135, ship date using a ship date text field 1137, or tollgate using a tollgate drop-down menu 1139. The user may also search requests by decision using a decision drop-down menu 1121 or by engineering code using, for example, a Pegasus text field 1123 and/or a C & CE text field 1133.

Open item searches are also possible in this embodiment. For example, a user may search for requests via open item closing date using an open item closed date text field 1125. Similarly the user may search for a request by entering the name of the person responsible for the open item associated with the request into an open item responsibility text field 1127. The user may also elect to use an open item status text field 1131 to search for various open items associated with one or more request items. Finally, a user may search by entering descriptive keywords into an open item description text field 1129 in order to search open items by key terms used to describe the open items.

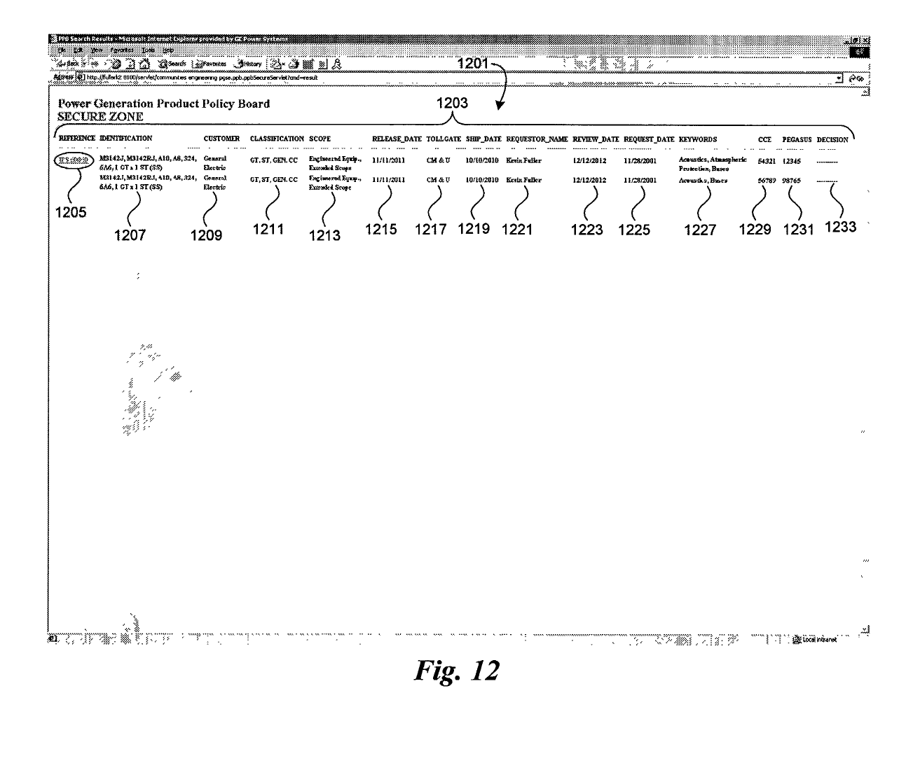

The search query page 1101 allows the user to select and customize the scope and format in which search results are returned. In this embodiment, the user may limit the information that is presented on a search results page, such as the search results page 1201 of FIG. 12, by checking one or more boxes in a return fields selection area 1141. For example, a user that wishes to view only review date and open item information may select the corresponding text fields and avoid having to sort through other types of information associated with a particular request or group of requests returned after a search.

Once the search parameters are entered into one or more search fields and all desired return fields 1141 are selected, the user may select a submit button 1143 to submit the search. Alternatively, the user may select a reset button 1145 in order to clear previously selected search parameters. Although specific examples of search options are described above, one skilled in the art would appreciate that many other search options and search methods may be utilized to search for requests and related information within the request tracking system. For example, full text searches may be used to search for terms present in any type of request information. Search options may also be customized for each user of the system.

FIG. 12 is an example of a search result page 1201. This page is displayed once the user selects the submit search button 1143 of FIG. 11. The page contains a row for each request item that satisfies the search request. In this example, two rows are displayed for the request items relating to the “IPS 0000” project. A return fields display area 1203 displays the fields selected by the user in the return fields selection area 1141 of FIG. 11. In this example, multiple return fields are displayed. A project reference number 1205 is displayed, along with unit identification information 1207, customer name information 1209, unit classification information 1211, scope information 1213, release date information 1215, tollgate information 1217, ship date information 1219, requester name information 1221, review date information 1223, request date information 1225, keywords information 1227, C & CE number information 1229, Pegasus number information 1231, and decision information 1233. Although the decision return field 1233 in this example is displayed, the information is left blank because decision information is not yet available.

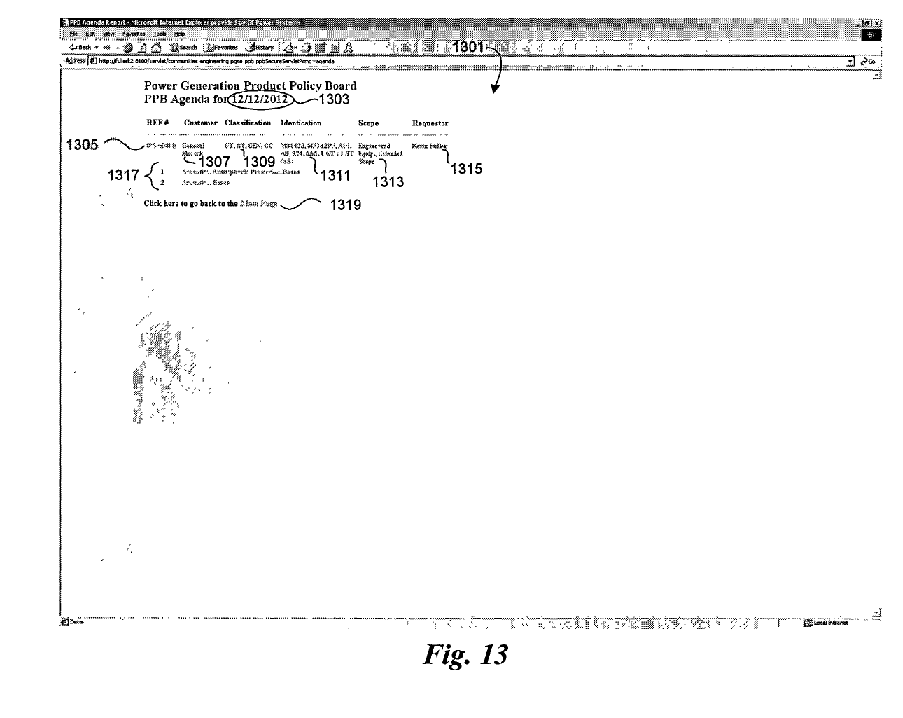

FIG. 13 is an example of an agenda list page 1301. The agenda list page 1301 displays information for request groups that are scheduled for review on a particular date or during a particular meeting. The agenda list page 1301 is displayed when the user submits a request to create a list of agenda items for review by entering a date into the create a list of agenda items for review text field 905 of FIG. 9 and selecting the submit button 911 of FIG. 9. The information displayed for each request group on the agenda list includes project reference number information 1305, customer name information 1307, unit classification information 1309, unit identification information 1311, scope information 1313, and requester information 1315. Additionally, request item keywords 1317 are displayed for each request item associated with the request group. In this particular example, only one request group, containing two request items, is scheduled for review on the given date (Dec. 12, 2012). From this page, a user may select to return to the main page by selecting the main page link 1319. Users can also click on the reference numbers 1305 to view the corresponding request.

Referring to FIGS. 14 through 20, various pages available to administrative users (e.g., review board members, production managers) are shown. FIG. 14 is an example of an administration options page 1401. An administrative user accesses this page via the administration section link 107 from the main page 101 of FIG. 1. The administration options page 1401 includes various text fields and drop-down menus that allow the administrative user to add data to the request tracking system 1403, delete data from the request tracking system 1407, edit data within the request tracking system 1411, review a request 1417, and edit a request 1419.

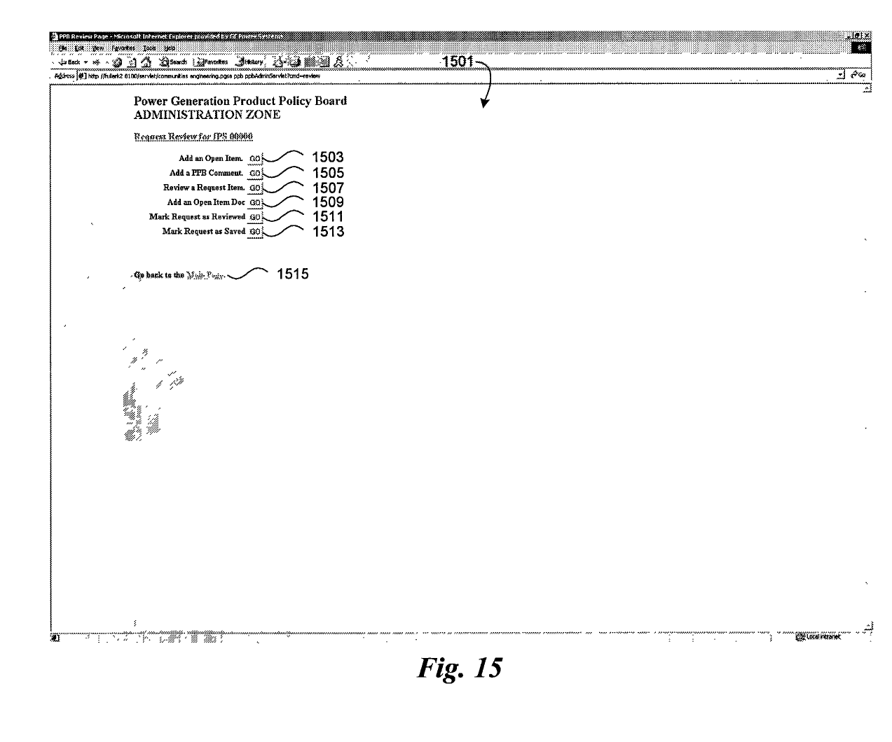

By using the review request drop-down menu to select a particular request by its project identification number, the administrative user in this embodiment may change the review status of the request, add open items, or add comments or notes to a particular request group or request item, as illustrated in FIG. 15. In this embodiment, if there is more than one submitted request group for a project reference number, multiple instances of the project reference number are available for selection from the drop-down menu (one instance for each request group). In other embodiments, the request tracking system may not permit multiple request groups to be submitted under a single project reference number.

The administrative user may select to edit a request by selecting a particular reference number from an edit request drop-down menu 1419. In this embodiment, the edit request drop-down menu contains a single instance of every project reference number in the database. When a particular project reference number is selected, project information and request group information for all requests groups associated the selected project reference number, including open items and supporting document information, is displayed on a single web page. The administrator may then add, delete, or modify information on the page.

The administration options web page 1401 may also be used to display brief notices to users, such as the notice 1423 provided in this particular example. The administrative user may edit the note by entering information into an edit admin note text field 1425. Similarly, the administrative user may delete the administrative note by selecting a delete admin note button 1429. The administrative user may return to the main page 101 of FIG. 1 by selecting a main page link 1431.

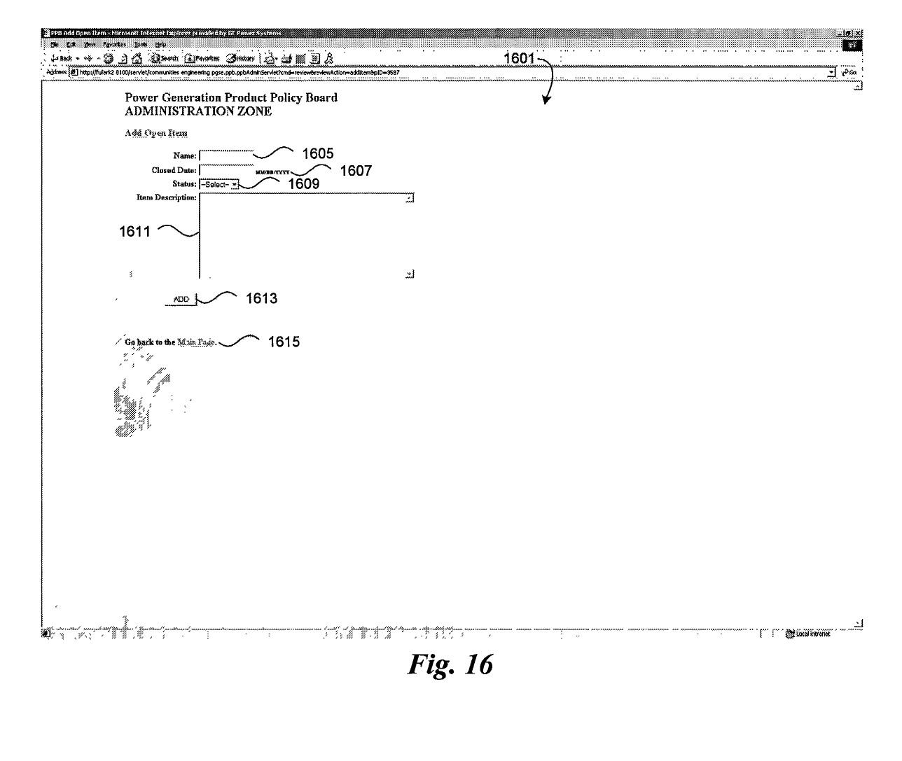

FIG. 15 is an example of a request review page 1501 associated with a particular project identification number, in this example “IPS 0000.” From this page the administrative user may add an open item to a particular request by selecting an add open item button 1503, add a comment to the request by selecting an add comment button 1505, review a request item by selecting a review request item button 1507, add an open item document to a particular request by selecting an add open item doc button 1509, mark a request as reviewed by selecting a mark request as reviewed button 1511, or mark a request as saved by selecting a marked request as saved button 1513. When the administrative user selects any of the buttons listed above, a corresponding page, such as one of the pages shown in FIGS. 16 through 19, is displayed, allowing the administrative user to make the desired changes. Additionally, the user may return to the main page by selecting a main page link 1515.

FIG. 16 is an example of an add open item page 1601. The administrative user may use the add open item page 1601 to enter open items for an existing project. The administrative user begins by entering the name of an individual responsible for the open item into a name text field 1605. Referring to the closed date text field 1607, the closed date reflects the date on which the open item is completed. Thus, the closed date text field 1607 is left blank until the open item is closed, at which point the date of the closing is entered. The administrative user then selects a status for the open item from a status drop-down menu 1609, which contains a list of status choices for each open item associated with a request group. A description of the open item is then entered into an item description text area 1611. To complete the addition of the open item, the administrative user selects an add open item button 1613. The administrative user may choose the option of returning to the main page by selecting a main page link 1615.

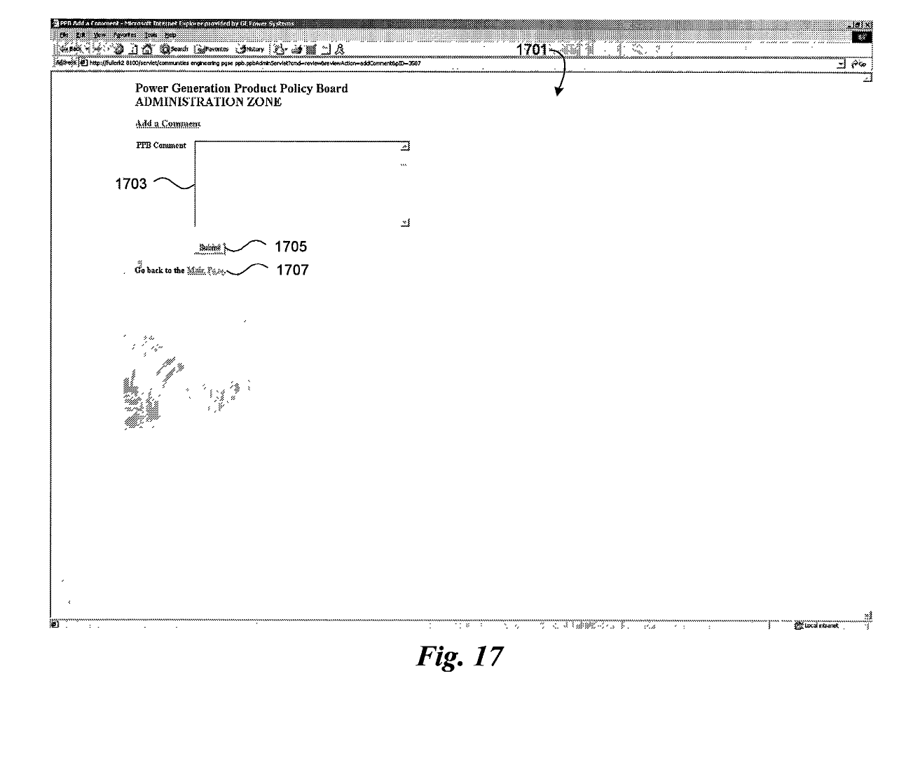

FIG. 17 is an example of an add a comment web page 1701. The administrative user inputs a comment directly into a comment text area 1703 and then selects a submit button 1705 to incorporate the comment into pre-existing request information. At any point, the administrative user may select a main page link 1707 to return to the main page 101 of FIG. 1.

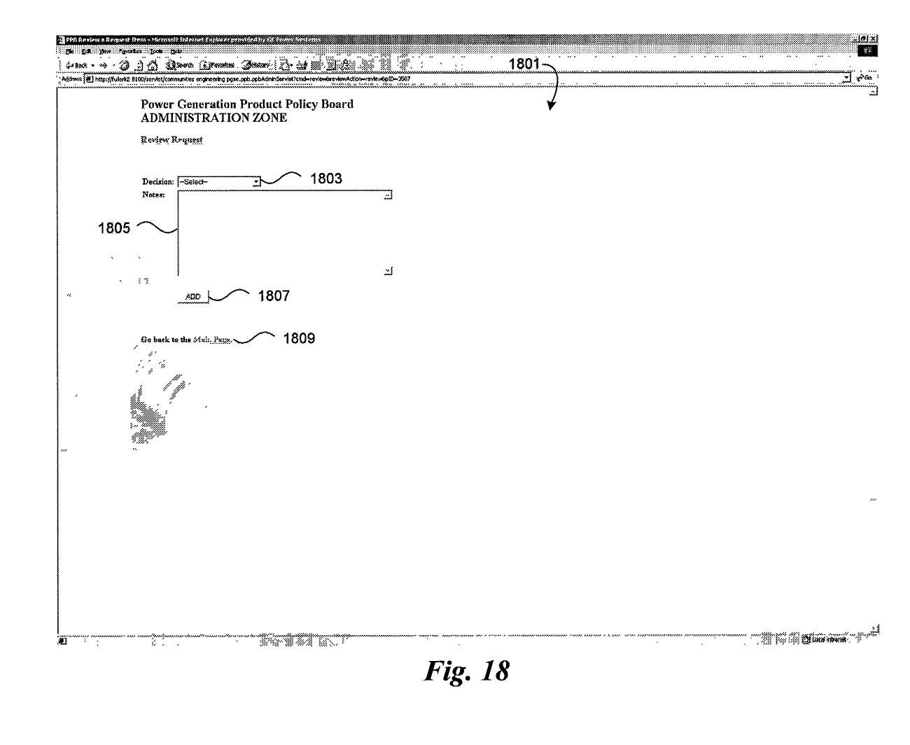

FIG. 18 is an example of a review request page 1801. The administrative user selects a decision status (e.g., accept, reject) from a decision drop-down menu 1803. Additionally, the administrative user may input notes regarding the status of the request or the decision into a notes text area 1805. To incorporate the decision and related notes into the pre-existing request information, the administrative user selects an add button 1807. At any time, the administrative user may select a main page link 1809 to return to the main page 101 of FIG. 1.

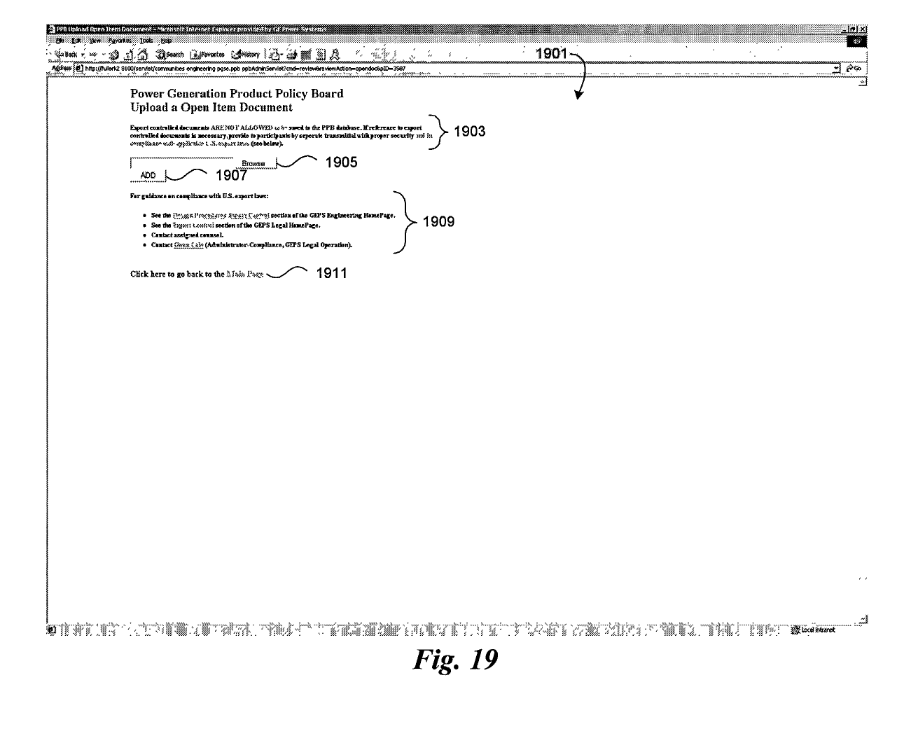

FIG. 19 is an example of an upload an open item document page 1901. Using this page, the administrative user may browse system accessible storage devices in search of documents related to open items by selecting a browse button 1905. After selecting an open item document, the administrative user selects an add button 1907 to incorporate a link to the document or to the document store within the tracking system into the existing request information associated with an open item. In this embodiment, export control rules apply to documents displayed in the request tracking system pages. Accordingly export control information 1903 and 1909 is provided for the administrative user, including links 1909 to export control information web pages. Additionally, the administrative user may return to the main page 101 of FIG. 1 by selecting a main page link 1911.

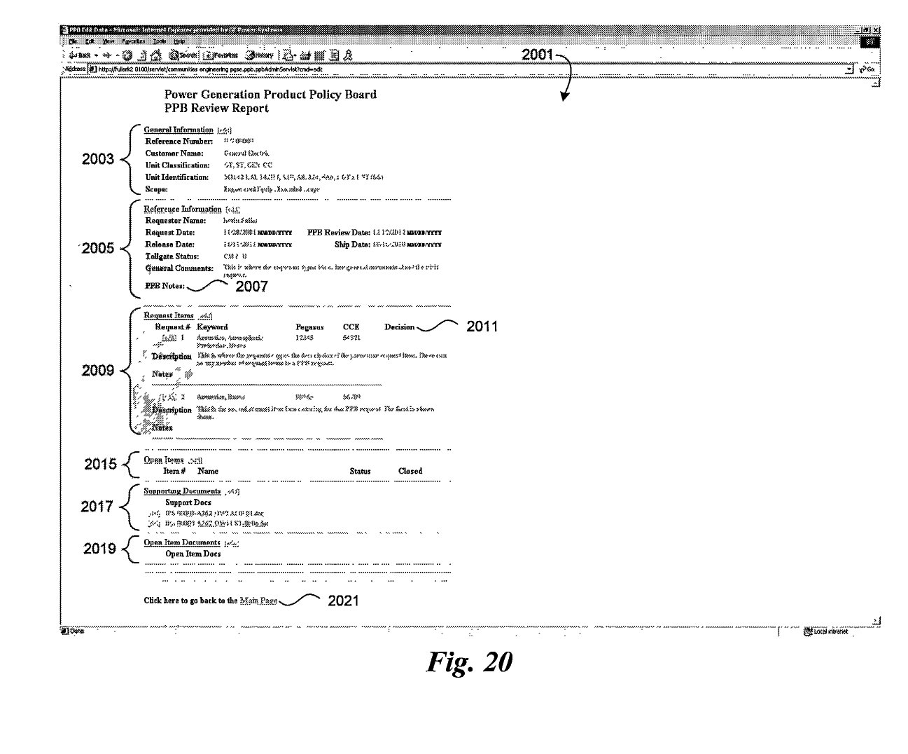

FIG. 20 is an example of a review report page 2001 that allows a user to view all request information related to a particular project reference number. A project information section 2003 is displayed, along with a request group information section 2005, which includes a notes section 2007. Although not shown in this particular illustration, if more than one request group exists for a particular project reference number, additional request group information is also displayed. For each request group information section, a request item section 2009 is displayed. The request item section in this embodiment includes an indication of a decision 2011 for each request item. In addition, a request item notes section 2013 displays administrative notes related to a particular request item.

In this embodiment, an open items section 2015 that contains a list of open items associated with a particular request group is also displayed. A support document section 2017 lists all supporting documents associated with a request group. In this particular embodiment, each support document list item includes a link to the corresponding support document located in a document storage device that is accessible by the system. Similarly, an open item document section 2019 displays open item document links. A user may return to the main page by selecting the main page link 2021.

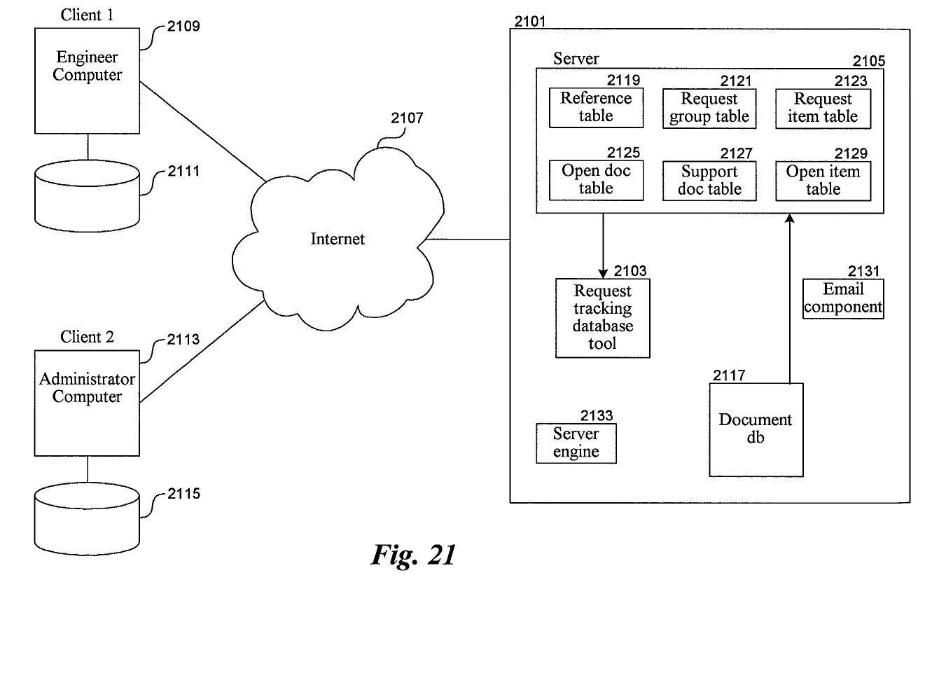

FIG. 21 is a block diagram illustrating components of the request tracking system in one embodiment. One or more client computers 2109 and 2113, and a server computer 2101 are interconnected via a network such as the Internet 2107 or an intranet. The computers may include a central processing unit, memory, input devices (e.g., keyboard and pointing devices), output devices (e.g., display devices and printers), and storage devices (e.g., optical and/or magnetic disk drives) all not shown in FIG. 21, but well known to those skilled in the relevant art. The memory and storage devices are computer-readable media containing computer instructions that implement the request tracking system.

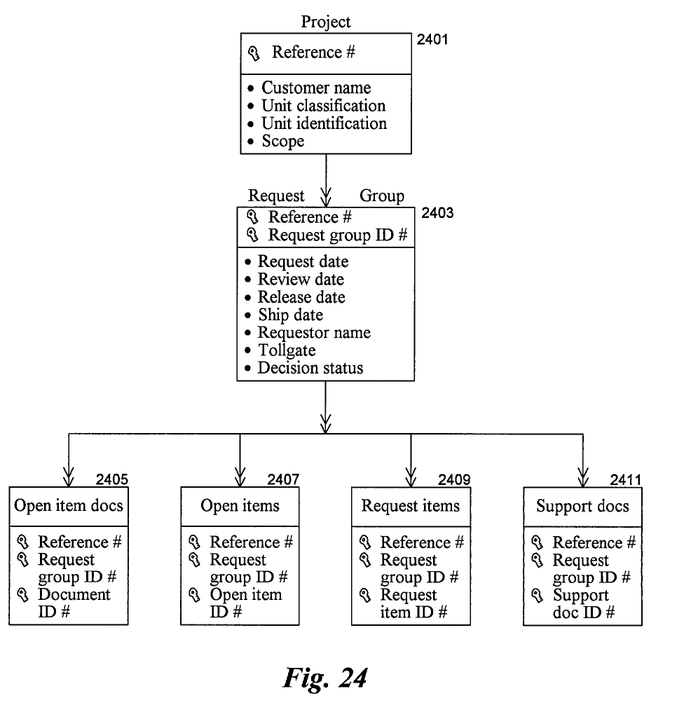

The server computer implements the request tracking system. The server computer system includes a server engine 2133, a database tool 2103, a request database 2105, and other local storage devices, such as a document store 2117. A server engine receives all request information submitted by users (e.g., web pages) as well as requests for reports by users. The request tracking database tool 2103 coordinates the compilation of request information and provides a user interface. The request tracking database tool 2103 stores request information in the request database 2105. The request tracking database 2105 includes a reference table 2119, a request group table 2121, a request item table 2123, an open document table 2125, a support document table 2127, and an open item table 2129, described in further detail in the descriptive text accompanying FIG. 24.

The document store 2117 stores documents that may be related to requests (e.g., open item documents, supporting documents) as well as other documents. The request tracking database tool 2103 allows for the retrieval of documents from the document database when a link to such a document is provided in a review report, such as the review report described with respect FIG. 10. The server computer 2101 is connected with other computers associated with the request tracking system, such as engineer user computers 2109 and administrative user computers 2113. Such computers may communicate via e-mail. Accordingly, the server computer may include an e-mail component 2131 to facilitate electronic communication between such computers. While wire connections are shown, the various computers may be connected via wireless connections. Additionally, the term “computer” as generally used herein, refers to any data processing device, including portable computers, palm top computers, personal digital assistance (PDA), Internet appliances, cellular or mobile telephones, wearable computers, set-top boxes, etc.

One skilled in the art will appreciate that the concepts of the above system can be used in various environments other than the Internet. For example, the concepts can also be used in an e-mail environment in which e-mail messages may be used exclusively to receive, report, and review request information, rather than relying on web-based forms for some aspect of the request tracking system. Also, various communication channels may be used, such as a local area network, wide area network, or a point-to-point dial-up connection instead of the Internet. The server system 2105 may comprise any combination of hardware or software that can support these concepts. In particular, a web server may include multiple computers. A client system may comprise any combination of hardware and software that interacts with the server system.

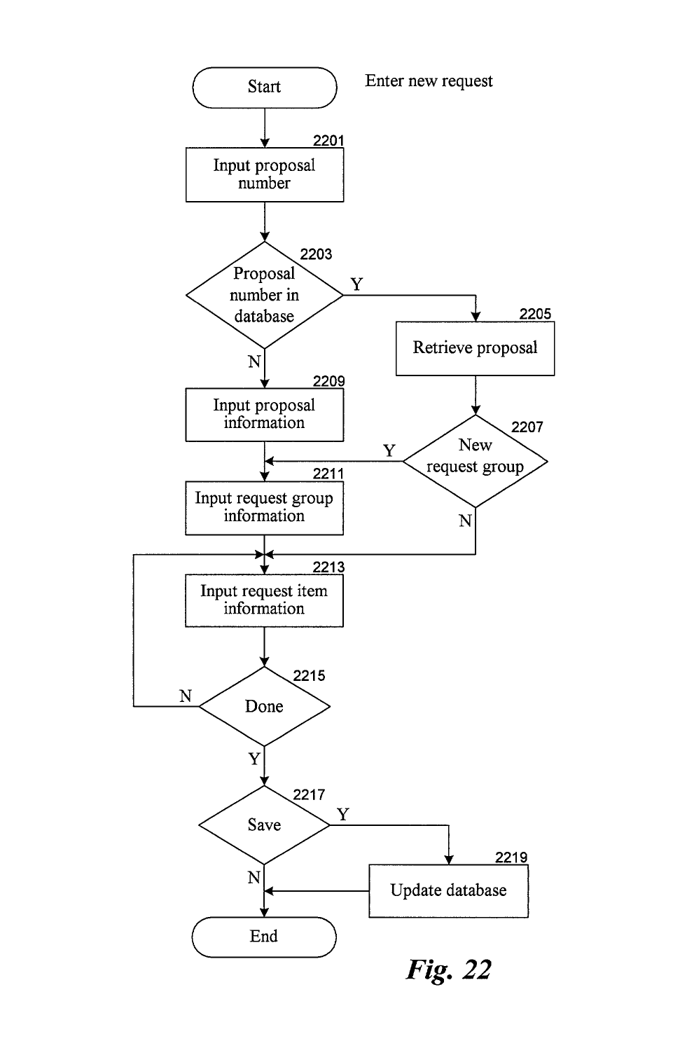

FIG. 22 is a flow diagram illustrating the entering of a new request into the request tracking system. In block 2201, the system inputs a project reference number related to a request or groups of requests. In decision block 2203, if the project number is already in the database, the routine continues at block 2205. Else, the routine continues at block 2209. In block 2205, the system retrieves the project information from the database. From block 2205 the routine continues at decision block 2207, where the system checks for new request group information. If new request group information is present, the routine continues at block 2211. If no new request group information is present, the routine continues at block 2213. In block, 2209, the system inputs proposal information. In block 2211, the system inputs request group information. In block 2213, the system inputs request item information. In decision block 2215, if the inputting of request information is complete, the routine continues at decision block 2217. Else, the system loops back to block 2213, where the system inputs request item information. In decision block 2217, if the system does not receive a selection from the user to save the request information, the routine ends. If, however, the system has received a selection from the user to save the request in decision block 2217, the routine continues at block 2219 where the system updates the database with the new request information. After the system updates the database, the routine ends.

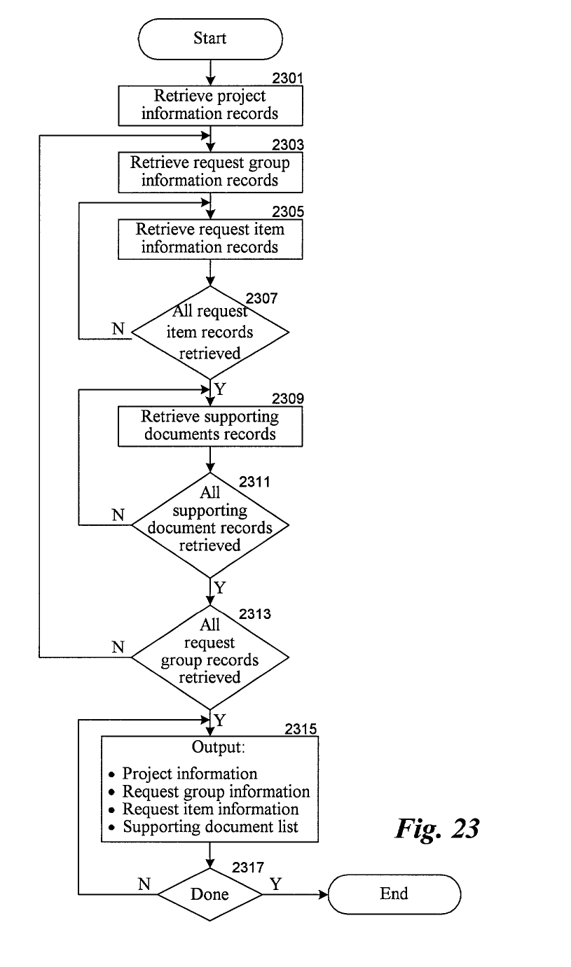

FIG. 23 is a flow diagram illustrating the displaying of request information. In block 2301, the system retrieves a project information record for a given project reference number. In block 2303, the system retrieves request group information for a given project reference number. In block 2305, the system retrieves request item information for each request group associated with the given project reference number. In decision block 2307, if all the request item records have been retrieved, the routine continues at block 2309. If, however, the system has not retrieved all the request item records in decision block 2307, the routine loops back to block 2305 where the system retrieves the next request item record for the request group. Once all request item records have been retrieved, the routine continues at block 2309 where the system retrieves supporting document information for the request group. The routine continues at decision block 2311 where, if all the request items have been retrieved, the routine continues at decision block 2313. Else, the routine loops back to block 2309, where the system retrieves the next supporting document record. In decision block 2113, if the system has retrieved all the request group records associated with the project reference number, the system continues at block 2315. Else, the routine loops back to block 2303 where the system retrieves the next request group record. In block 2315 the system outputs proposal information, request group information, request item information, and supporting document information. In decision block 2317, if all request information has been outputted, the routine ends. Else, the routine loops back to 2313 until all request item information is outputted.

FIG. 24 is a block diagram illustrating data structures of a sample database in one embodiment. The database includes a project reference information table 2401, a request group information table 2403, a request items table 2409, an open items table 2407, an open item documents table 2405, and a supporting documents table 2411. The project reference information table 2401 contains a project reference identifier for each project in the system. The information stored for each project in the project reference table includes customer name information, unit classification information, unit identification information, and project scope information.

The request group information table 2403 contains information relating to request groups for the projects. Each request group relates back to a project by a project reference number field and is assigned a request group identification number to uniquely identify it within the project. The information stored for each request group in the request group table includes request date information, review date information, release date information, ship date information, requester name information, tollgate information, and project status.

Block 2409 is a request items table that contains information relating to one or more request items for the request groups. Each request item relates back to a request group by a request group identification number and is assigned a request item identification number that uniquely identifies it within the request group. The information stored for each request item includes engineering code information (e.g., Pegasus code and C & CE code), decision information, description information, and keyword information.

Block 2407 is an open items table that contains information relating to the open items for the request groups. Each open item relates back to a request group by a request group identification number and is assigned an open item identification number that uniquely identifies it with the request group. The information stored for each open item in the open items table includes responsible person information, open item status information, closed date information, and open item description information.

Block 2405 is an open item documents table that contains information relating to the open item documents for the request groups. Each open item document relates back to a request group by a request group identification number field and is assigned an open item document identification number to uniquely identify it with the request group. Similarly, block 2411 is a supporting documents table, which contains information relating to the supporting documents for the request groups. Each supporting document is assigned a supporting document identification number that uniquely identifies it within the request group. The information stored for each supporting document and open item document may include path and file name information for the document, which is stored in a document store accessible by the request tracking system.

From the foregoing, it will be appreciated that specific embodiments of the invention have been described herein for purposes of illustration, but that various modifications may be made without deviating from the spirit and scope of the invention. For example, although one schema for storing information is described above, many other data schemas may be employed to organize information in a manner that best suits a particular product or industry context. Additionally, while the above description provides specific examples of the types of information that may be tracked using the techniques described herein, one skilled in the art would appreciate that many other types of information related to requests for deviations from products may be tracked using the techniques described herein, such as information pertaining to physical products, services, testing, and inspections as well as product items within the scope of a project. Moreover, the teachings of the invention provided herein can be applied to other electronic customer information and product development tracking systems, not necessarily the request tracking system described above. Accordingly, the invention is not limited except as by the appended claims.

We claim:

1. A method in a computer for organizing and tracking information associated with requests for deviations from a product, the method comprising:
providing a hierarchical organization, the hierarchical organization specifying categories for project identification information, request group information, and request item information;
receiving project identification information associated with one or more requests for deviations from the product;
receiving request group information for a request group, the request group relating to the received project identification information;
receiving request item information for a request item, the request item relating to the received request group information; and
storing the received information.

2. The method of claim 1 wherein the project identification information includes a project reference number.

3. The method of claim 1 wherein the project identification information includes a customer name.

4. The method of claim 1 wherein the project identification information includes unit classification information and unit identification information.

5. The method of claim 1 wherein the project identification information includes project scope information.

6. The method of claim 1 wherein the request group information includes information relating to dates associated with the product.

7. The method of claim 1 wherein the request group information includes a request date.

8. The method of claim 1 wherein the request group information includes a requestor name.

9. The method of claim 1 wherein the request group information includes requester comments.

10. The method of claim 1 wherein the request item information includes keywords for the request item.

11. The method of claim 1 wherein the request item information includes a description of the request item.

12. The method of claim 1 wherein the hierarchical organization specifies a category for supporting document information.

13. The method of claim 12 further comprising receiving supporting document information for a supporting document, the supporting document containing information that provides support for the request group.

14. The method of claim 13 wherein the supporting document information includes a link to the supporting document.

15. The method of claim 1 wherein the hierarchical organization specifies a category for open item information and specifies a category for open item documents.

16. The method of claim 15 further comprising receiving open item information for an open item, the open item relating to the received request group information.

17. The method of claim 16 further comprising receiving open item document information, the open item document containing information associated with an open item for the request group.

18. The method of claim 17 wherein the open item document information includes a link to the open item document.

19. The method of claim 1 wherein the received request group information includes scheduling information for reviewing the request group.

20. The method of claim 1 further comprising:
receiving a request to retrieve the stored information;
retrieving the stored information; and
sending the retrieved information.

21. The method of claim 20 wherein the retrieved information includes project identification information, request group information, and request item information.

22. The method of claim 21 wherein the retrieved information includes supporting document information.

23. The method of claim 22 wherein the retrieved information includes open item information.

24. The method of claim 23 wherein the retrieved information includes open item document information.

25. A method in a computer for tracking requests for deviations, the method comprising:
receiving information associated with the requests for deviations;
storing the received information associated with the requests for deviations;
generating a report of the stored information for review of the requests for deviations; and
after review of the requests for deviations, receiving an indication of a decision whether to deviate; and
when the received decision indicates that more information related to the requests for deviations is needed,
receiving an indication of open items associated with the requests;
tracking completion of the open items; and
receiving a final decision whether to deviate.

26. The method of claim 25 further comprising receiving additional information for modifying the received information associated with the request for deviations.

27. The method of claim 25 wherein the received information includes project information, the project information including a project reference number.

28. The method of claim 25 wherein the received information includes request group information for at least one request group, the request group information including scheduling information for reviewing the requests for deviations.

29. The method of claim 28 wherein the request group information further includes a requester name.

30. The method of claim 28 wherein the request group information further includes requestor comments.

31. The method of claim 28 wherein the request group information further includes information relating to dates associated with the deviation.

32. The method of claim 28 wherein the received information includes request item information, the request item information including keywords associated with a request item, the request item relating to a request group.

33. The method of claim 32 wherein the request item information further includes a description of the request item.

34. The method of claim 28 wherein the received information includes supporting document information for supporting documents, the supporting documents relating to a request group.

35. The method of claim 28 wherein the indication of open items includes open item document information for open item documents, the open item documents relating to the open items.

36. The method of claim 26 including generating an electronic mail message indicating that the requests for deviations are scheduled for review.

37. The method of claim 26 further comprising:
receiving a search request, wherein the search request includes one or more search criteria;
searching for one or more request groups that satisfy the search criteria; and
providing search results.

38. A method in a computer for tracking requests for deviations from a product, the method comprising:
receiving project identification information associated with one or more requests for deviations from the product;
receiving request group information for a request group, the request group relating to the received project identification information;
receiving request item information for a request item, the request item relating to the received request group information;
storing the received information;
generating a report of the stored information for review of a request group; and
after review of the request group,
receiving an indication of a decision whether to deviate from the product; and
when the received decision indicates that more information related to the request group is needed,
receiving an indication of an open item associated with the request group;
when the open item is completed, generating a report relating to open items, and
receiving a final decision whether to deviate from the product.

39. The method of claim 38 further comprising receiving supporting document information for supporting documents, the supporting documents relating to the request group.

40. The method of claim 38 wherein the indication of an open item includes open item document information for open item documents, the open item documents relating to the open item.

41. The method of claim 38 including sending an electronic mail message indicating that the requests for deviations are scheduled for review.

42. The method of claim 38 wherein the generated report relating to open items is contained within an electronic mail message.

43. The method of claim 38 further comprising:
receiving a search request, wherein the search request includes one or more search criteria;
searching for one or more request groups that satisfy the search criteria; and
providing search results.

44. The method of claim 38 wherein the received decision information is provided by a user in an administrative role.

45. A method in a computer for tracking requests for deviations from a product, the method comprising:
providing information associated with requests for deviations, wherein the stored information is organized using hierarchical categories, the hierarchical categories including project identification information, request group information, and request item information;
receiving from a user criteria for retrieving the stored information, the criteria associated with one or more of the provided hierarchical categories;
searching for the stored information using the received criteria;
when information corresponding to the received criteria is found, generating search results, the search results including indications of the found information; and
sending to the user the search results.

46. The method of claim 45 wherein the hierarchical categories further include supporting document information, open item information, and open item document information.

47. The method of claim 45 wherein the search results are sent to the user within an electronic mail message.

48. The method of claim 45 wherein the search results are sent to the user in a web page.

49. The method of claim 45 further comprising receiving from the user indications for displaying one or more information fields within the search results.

50. A computer-readable medium containing a data structure for use by a request tracking system, the data structure comprising:
a project table having entries for projects;
a request group table having entries for request groups, each entry for a request group being mapped to an entry for a project; and
a request item table having entries for requests items, each entry for a request item being mapped to an entry for a request group.

51. The computer-readable medium of claim 50 further comprising:
a supporting documents table having entries identifying documents that support request groups, each entry for a request item being mapped to an entry for a request group; and
a mapping from request groups to supporting documents.

52. The computer-readable medium of claim 50 further comprising:
an open item table having entries for open items, each entry for an open item being mapped to an entry for a request group; and
an open item documents table having entries identifying documents associated with a request group, each entry for a document being mapped to an entry for a request group.

53. A computer-readable medium containing instructions to perform a method comprising:
receiving project identification information for a plurality of projects;
receiving request group information for a request group relating to the received project identification information;
receiving request item information relating to received request group information and identifying a request for a deviation from a product; and
storing the received information.

54. The computer-readable medium of claim 53 wherein the stored information is organized hierarchically, wherein further the hierarchical organization includes project identification information, request group information, and request item information.

55. The computer-readable medium of claim 54 wherein the hierarchical organization further includes supporting document information.

56. The computer-readable medium of claim 54 wherein the hierarchical organization further includes open item information and specifying a category for open item documents.

57. A computer-readable medium containing instructions for controlling a computer to perform a method comprising:
receiving information associated with requests for deviations;
storing the received information using an organization of information categories;
generating a report of the stored information for review of the requests for deviations; and
after review of the requests, receiving a final decision whether to deviate.

58. The computer-readable medium of claim 57 wherein the final decision whether to deviate from the product is received after receiving an indication of open items associated with the requests and tracking completion of the open items.

59. The computer-readable medium of claim 57 wherein the indication of an open item includes open item document information for open item documents, the open item documents relating to the open item.

60. The computer-readable medium of claim 57 wherein the generated report relating to open items is contained within an electronic mail message.

61. A computer-readable medium containing instructions for performing a method comprising:
receiving project identification information for a plurality of requests for deviations from a product;
receiving request group information for a plurality of request groups, the request groups relating to a project;
receiving request item information for a plurality of request items, the request items relating to a request group;
storing the received information;
generating a report of the stored information for review of a request group; and
receiving a final decision whether to deviate from the product.

62. The computer-readable medium of claim 61 wherein the final decision whether to deviate from the product is received after receiving an indication of open items associated with the requests and after tracking completion of the open items.

63. The computer-readable medium of claim 62 wherein the indication of an open item includes open item document information for open item documents, the open item documents relating to the open item.

64. The computer-readable medium of claim 61 including generating an electronic mail message indicating that the requests for deviations are scheduled for review.

65. The computer-readable medium of claim 61 wherein the generated report relating to open items is contained within an electronic mail message.

66. A computer-readable medium containing instructions for controlling a computer to track requests for deviations from a product by a method comprising:
providing information stored in a database, the information associated with requests for deviations, wherein the stored information is organized using hierarchical categories, the hierarchical categories including project identification information, request group information, and request item information;
receiving from a user criteria for retrieving the stored information, the criteria associated with one or more of the provided hierarchical categories;
searching for the stored information in the database using the received criteria;
when information corresponding to the received criteria is found, generating search results, the search results including indications of the found information; and
sending to the user the search results.

67. The computer-readable medium of claim 66 wherein the hierarchical categories further include supporting document information, open item information, and open item document information.

68. The computer-readable medium of claim 66 wherein the search results are sent to the user within an electronic mail message.

69. A computer system for organizing and tracking information associated with requests for deviations from a product comprising:
means for receiving project identification information associated with one or more requests for deviations from the product;
means for receiving request group information for a request group, the request group relating to the received project identification information;
means for receiving request item information for a request item, the request item relating to the received request group information; and
means for storing the received information.

70. The computer system of claim 69 further comprising means for receiving open item information for an open item, the open item relating to the received request group information.

71. The computer system of claim 69 further comprising receiving open item document information, the open item document containing information associated with an open item for the request group.

72. A computer system for tracking requests for deviations from a product comprising:
means for receiving project identification information associated with one or more requests for deviations from the product;
means for receiving request group information for a request group, the request group relating to the received project identification information;
means for receiving request item information for a request item, the request item relating to the received request group information;
means for storing the received information;
means for generating a report of the stored information for review of a request group;
means for receiving an indication of an initial decision whether to deviate from the product;
means for receiving an indication of an open item associated with the request group;
means for generating a report relating to open items, and
means for receiving a final decision whether to deviate from the product.

73. The computer system of claim 72 further comprising means for receiving supporting document information for supporting documents.

74. The computer system of claim 72 further comprising:
means for receiving a search request, wherein the search request includes one or more search criteria;
means for searching for one or more request groups that satisfy the search criteria; and
means for providing search results.

75. A computer system for tracking requests for deviations from a product, comprising:
means for providing information stored in a database, the information associated with requests for deviations, wherein the stored information is organized using hierarchical categories, the hierarchical categories including project identification information, request group information, and request item information;
means for receiving from a user criteria for retrieving the stored information, the criteria associated with one or more of the provided hierarchical categories;
means for searching for the stored information in the database using the received criteria;
means for generating search results, the search results including indications of the found information; and
means for sending to the user the search results.

76. The computer system of claim 75 further comprising means for receiving from the user indications for displaying one or more information fields within the search results.
